(19) United States
(12) Patent Application Publication
(10) Pub. No.: US 2006/0230345 A1
(43) Pub. Date: Oct. 12, 2006

(54) Portable data storage device that converts data types and data type converting method

(76) Inventors: Shih-Hsiung Weng, Taipei City (TW); Koon Wei Tan, Penang (MY)

Correspondence Address: RABIN & Berdo, PC, 1101 14TH STREET, NW, SUITE 500, WASHINGTON, DC, 20005, US

(21) Appl. No.: 11/100,419

(22) Filed: Apr. 7, 2005

(51) Int. Cl. G06F 17/00

(52) U.S. Cl. 715/523

(57) ABSTRACT

A portable data storage device that converts data types and a data type converting method are disclosed. The data conversion function is integrated into the data storage device so that it can convert the data types as well as store data. This function enables the data storage device to make good use of the storage space by converting the data into a desired type.

### BACKGROUND OF THE INVENTION

1. Field of Invention

The invention relates to a portable data storage device that converts data types and a data type converting method.

2. Related Art

In observation of the prosperous development in software and the coming digital multimedia age, people have higher demands for data storage devices. In addition to a larger capacity, convenience is another factor. To satisfy different needs, there are many different kinds of data storage devices. In particular, portable data storage devices have played an important and indispensable role in the realm of mobile business.

However, different portable data storage devices have their intrinsic drawbacks. For example, the need to convert data types among different devices makes them difficult to use, or one has to install appropriate software in order to open the files. Even after the portable data storage device completes the data transfer, specific software has to be used to make file type conversions. These facts limit the applications of the portable data storage devices.

Besides, the capacities of existing portable data storage devices grow slower than the expanding speed of information or software to be stored. In particular, demands for higher quality pictures result in large-size picture files. This greatly restricts the number of picture files that can be stored in a portable data storage device. It is therefore a common solution to convert picture files in the format that occupies large space into ones in the format that occupies less.

As described, if the portable data storage device can provide the file type conversion function, the problem of converting file types can be immediately solved. It is then convenient to both convert files from a large-size format to a small-size format and store them. Consequently, how to provide a portable data storage device that has the file type conversion function is the direction that all manufacturers should go after.

### SUMMARY OF THE INVENTION

In view of the foregoing, the invention provides a portable data storage device that converts data types and a data type converting method. An object of the invention is to combine the data conversion function to the data storage device for the access of electronic data in various formats and for converting them into a desired data format.

A further object of the invention is to, through the data type conversion, accommodate more data in a portable data storage device of a fixed capacity.

To achieve the above objects, the disclosed portable data storage device includes: a central processing unit (CPU), a data storage module, and a transmission interface module. The CPU contains a data transmission interface, a management module, a file examination module, and a coding module.

The transmission interface module is used to connect the CPU and a host computer for the transfer of data and information. Using the data transmission interface of the CPU, the file examination module examines the data files, after receiving them from the host computer, to find out the file type of the data and notify the management module the analysis result. At the same time, the management module sends out a notification message to the host computer and receives from the host computer a command for executing and/or abandoning file type conversions. The coding module receives the file type conversion command from the management module and converts the file into one that complies with the specified file type. The data storage module is used for storing data files and those files that complies with the specified file type. The management module stores the data in the data storage module. It further controls the file examination module, the coding module, and the storage module, as well as exchanges information and commands with the host computer.

Moreover, to use the disclosed data type converting method, the portable data storage device is first connected to a host computer for file transfer and file type conversions. The method includes the steps of: receiving a file from a host computer; examining the file to find out its file type and data stored therein; ensuring that the file is not compliant with a specified format that is predetermined and stored in the portable storage device; sending a notification message to the host computer; confirming a file format conversion for the file; performing the file format conversion to convert the file into the desired format; and storing the file of the correct format.

### BRIEF DESCRIPTION OF THE DRAWINGS

The invention will become more fully understood from the detailed description given hereinbelow illustration only, and thus are not limitative of the present invention, and wherein:

FIG. 1 shows the functional structure according to an embodiment of the invention;

FIG. 2 is a flowchart showing how the first embodiment operates; and

FIG. 3 is a flowchart showing how the second embodiment operates.

### DETAILED DESCRIPTION

The disclosed portable data storage device that converts data types and the data type converting method combines the data conversion function to a data storage device for access electronic data in various formats and convert them into a desired format.

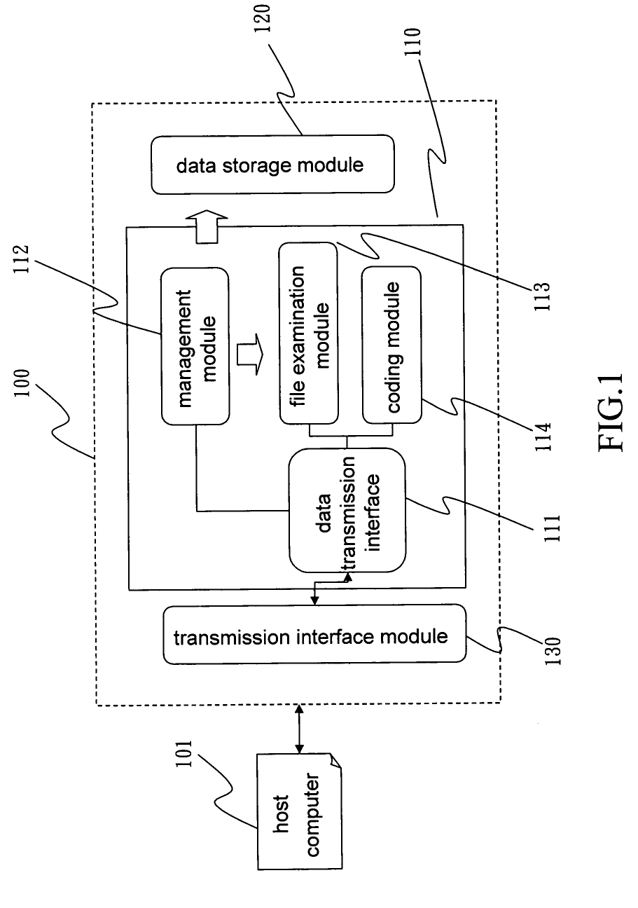

As shown in FIG. 1, the data storage device 100 contains: a CPU 110, a data storage module 120, and a transmission interface module 130. The transmission interface module 130 provides the connection between the CPU 110 and a host computer 101 for the exchange of files, information and commands. The data storage module 120 stores data files and converts them into a desired format.

With further reference to FIG. 1, the CPU 110 contains: a data transmission interface 111, a management module 112, a file examination module 113, and a coding module 114. The data transmission interface 111 plays the role of a transmission interface for the management module 112, the file examination module 113, and the coding module 114 to the transmission interface module 130.

The management module 112 is sued to control the file examination module 113, the coding module 114, and the data storage module 120. It further exchanges information and commands with the host computer 101. It sends out notification messages to and receives commands from the host computer 101.

The file examination module 113 examines the data files received from the host computer 101 in order to find out the format and data in the data file. It further notifies the management module 112 of the analysis result.

The coding module 114 receives the file format conversion command from the management module 112 and converts the file into a desired format.

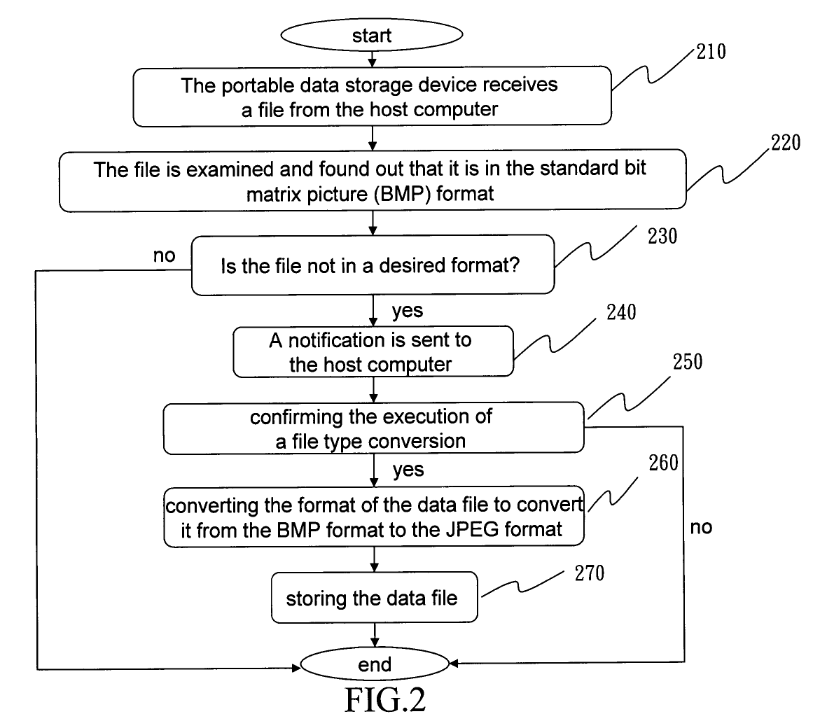

We use FIG. 2 to illustrate the operation of the invention in its first embodiment. First, a portable data storage device that converts data types is connected to a host computer to perform a data file transfer and a file type conversion. Afterwards, the portable data storage device receives a file from the host computer (step 210). The file is examined and found out that it is in the standard bit matrix picture. (BMP) format (step 220). Suppose the file is not in a desired format (step 230), which in this embodiment is the Joint Photographic Experts Group (JPEG) format. Afterwards, a notification is sent to the host computer (step 240) for the user to determine whether a file format conversion is necessary. Step 250 confirms the execution of a file type conversion. Step 260 converts the format of the data file to convert it from the BMP format to the JPEG format. Step 270 stores the data file. In particular, the step of sending a notification to the host computer further includes the step of displaying the space occupied by the data file before and after the conversion and the available free space.

If the file is already in the correct format (step 230), step 270 is followed to store the data. If it is not necessary to execute a file type conversion in step 250, then step 270 is directly followed. The setting for file conversion in the invention can be the file size. That is, when the space occupied by a file is smaller than a certain value, there is no need to go through the step of file conversion confirmation. The setting can be the file format. That is, certain types of files are not needed to be converted and are stored directly.

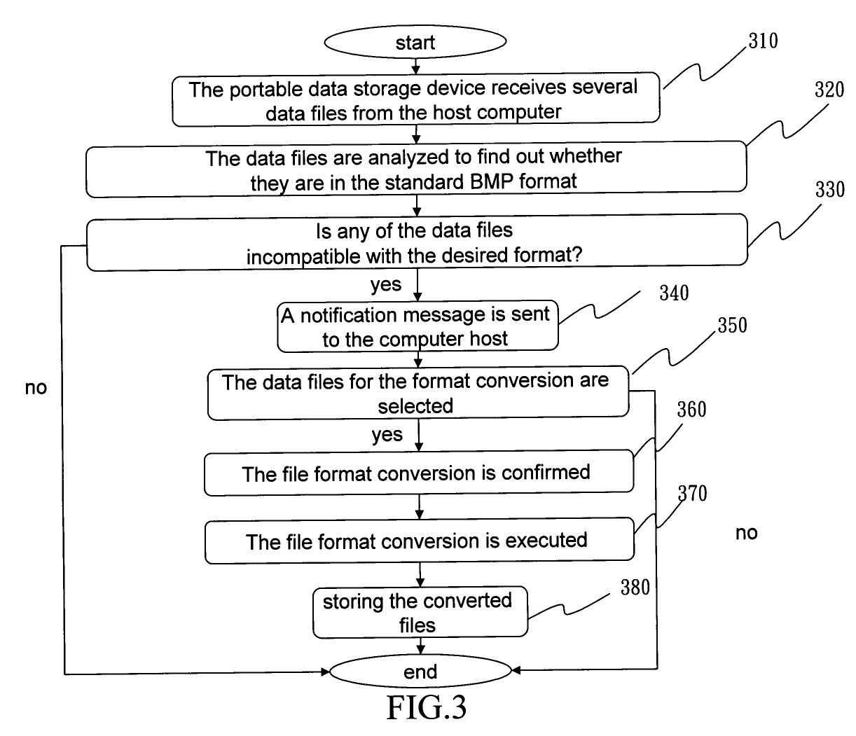

Moreover, the portable-data storage device that can convert data types often transmits multiple files. The invention can also perform format conversions for several files at a time. FIG. 3 is the flowchart illustrating how the second embodiment of the invention operates.

Likewise, the portable data storage device that can convert data types is connected to a computer host for file transfers and file format conversions. In step 310, the portable data storage device receives several data files from the host computer. The data files are analyzed to find out whether they are in the standard BMP format in step 320. In step 330, the data files are checked to see if any of them is incompatible with the desired format. In this embodiment, we set the desired format to be the JPEG format. In step 340, a notification message is sent to the computer host for the user to determine whether a file format conversion is needed. In step 350, the data files for the format conversion are selected. The file format conversion is confirmed in step 360 and executed in step 370. The BMP files are thus converted into JPEG files. Step 380 stores the converted files. In particular, the step of sending a notification message to the computer host further includes the step of displaying the space occupied by the data file before and after the conversion and the available free space.

If the files are compliant with the desired format, then step 330 is directly followed by step 380 to store the data files. If no file is selected in step 350, then step 380 is directly performed to store the files.

Certain variations would be apparent to those skilled in the art, which variations are considered within the spirit and scope of the claimed invention.

What is claimed is:

1. A portable data storage device that converts data types, connecting to a host computer to perform the transfer of a data file and file type conversion, comprising:
a central processing unit (CPU), which includes:
a file examination module, which examines the file received from the host computer and analyzes its format and information therein, obtaining an analysis result;
a coding module, which converts the format of the data file into a predetermined format;
a file examination module, which receives the file from the host computer and examines the format and information of the data file;
a management module, which controls the file examination module, the coding module, and the data storage module, exchanges messages and commands with the host computer, receives the information of the file from the file examination module, sends a notification message to the computer host, and receives a command for executing/abandoning file conversion from the host computer; and
a data transmission interface, which connects to the management module, the file examination module, and the coding module as a transmission interface to the computer host;
a data storage module, which stores the data file and the data file converted into the predetermined format; and
a transmission interface module, which connects the CPU to the computer host to perform the transfer of data files, messages and commands.

2. The portable data storage device that converts data types of claim 1, wherein the criterion for file format conversion is set as the space occupied by the data file in the storage medium.

3. The portable data storage device that converts data types of claim 1, wherein the predetermined format is a predetermined file format.

4. A data format converting method for a portable data storage device that connects to a host computer to perform the transfer of a data file and file type conversion, the method comprising:
(a) receiving a data file from the computer host;
(b) examining the data file to find out the format and information of the data file;
(c) sending a notification message to the computer host;
(d) confirming the execution of file format conversion of the data file;
(e) converting the format of the data file so that the data file is compliant with a specific setting; and
(f) storing the data file.

5. The method of claim 4, wherein the specific setting is the space occupied by the data file in the storage medium.

6. The method of claim 4, wherein the specific setting is a predetermined file format.

7. The method of claim 4, wherein step (d) further includes the step of displaying on the computer host the space occupied by the file incompliant with the specific setting before and after the file type conversion and the available space.

8. A data format converting method for a portable data storage device that connects to a host computer to perform the transfer of a data file and file type conversion, the method comprising:
(a) receiving a plurality of data files from the computer host;
(b) examining the data files to find out the formats and information of the data files;
(c) confirming that a plurality of the data files are incompliant with a setting that is predetermined and stored in the portable data storage device;
(d) sending a notification message to the computer host;
(e) selecting the data files to be converted in the format;
(f) converting the formats of the selected data files so that the data files are compliant with the specific setting; and
(g) storing the data files.

9. The method of claim 8, wherein the specific setting is the space occupied by the data file in the storage medium.

10. The method of claim 8, wherein the setting is a predetermined file format.

11. The method of claim 8, wherein step (d) further includes the step of displaying on the computer host the space occupied by the file incompliant with the specific setting before and after the file type conversion and the available space.
